(19) United States
(12) Patent Application Publication
(10) Pub. No.: US 2008/0307014 A1
(43) Pub. Date: Dec. 11, 2008

(54) COMPRESSING FILES USING A MINIMAL AMOUNT OF MEMORY

(76) Inventor: Manoj Chudaman Patil, Pune (IN)

Correspondence Address: IBM CORP (YA);C/O YEE & ASSOCIATES PC, P.O. BOX 802333, DALLAS, TX, 75380, US

(21) Appl. No.: 11/758,992

(22) Filed: Jun. 6, 2007

(51) Int. Cl. G06F 17/30

(52) U.S. Cl. 707/204; 707/E17.01

(57) ABSTRACT

A computer implemented method, apparatus, and computer program code for compressing a file in a computer. An amount of memory available for use in the computer is determined. A size of the file is determined. A chunk size is determined based on the size of the file and the amount of memory available for use. A set of chunks are created by obtaining a chunk of chunk size from the file, and truncating the file an amount equal to the chunk size, until the file is completely truncated. A new file containing compressed chunks is created by repeatedly selecting a chunk from the set of chunks, compressing the chunk to form a compressed chunk, writing the compressed chunk to the new file, and deleting the chunk from the set of chunks, until each chunk in the set of chunks is deleted. The new file containing the compressed chunks is saved.

### BACKGROUND OF THE INVENTION

1. Field of the Invention

The present invention relates generally to data processing systems and in particular to file compression. Still more particularly, the present invention relates to a computer implemented method, apparatus, and computer program code for compressing files using a minimal amount of memory.

2. Description of the Related Art

In a computer system, memory is a limited resource. Therefore, software applications and other users of memory typically use memory in a way that conserves memory, such that memory is available for all users of memory. In this context, memory refers to both short-term memory, such as solid state-based random access memory, and long-term memory, such as disk drives. Devices with relatively small amounts of memory, such as personal digital assistants (PDA) or cellular/wireless phones, are particularly sensitive to memory usage.

One popular way of conserving memory is file compression, in which a file is compressed so that the compressed file is smaller than the original file. The compressed form of the file is then stored in memory instead of the original file to conserve memory. There are many different compression utilities available, such as zip, gzip, tar, and archive. Each compression utility uses one or more techniques, called algorithms, for compressing a file.

A compression utility is typically used to compress a file when there is a need to conserve memory. However, in order to compress the file, the compression utility requires memory. At a minimum, the compression utility requires enough memory to hold the original file and the compressed file. The compression utility may also need additional memory to temporarily hold intermediate files which are created during the process of compressing the file, but which are deleted once the compressed file is created. If there is insufficient memory for the compression utility to use when creating the compressed file, the compression utility will abort the compression operation when the memory is used up.

### SUMMARY OF THE INVENTION

The illustrative embodiments described herein provide a computer implemented method, apparatus, and computer program code for compressing a file in a computer. An amount of memory available for use in the computer is determined. A size of the file is determined. A chunk size is determined based on the size of the file and the amount of memory available for use. A set of chunks are created by obtaining a chunk of chunk size from the file, and truncating the file an amount equal to the chunk size, until the file is completely truncated. A new file containing compressed chunks is created by repeatedly selecting a chunk from the set of chunks, compressing the chunk to form a compressed chunk, writing the compressed chunk to the new file, and deleting the chunk from the set of chunks, until each chunk in the set of chunks is deleted. The new file containing the compressed chunks is saved.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system in which illustrative embodiments may be implemented;

FIG. 2 is a block diagram of software components in accordance with an illustrative embodiment;

FIG. 3 is a block diagram illustrating a file compression in accordance with an illustrative embodiment; and

FIG. 4 is a flowchart of a process for compressing a file in accordance with an illustrative embodiment.

### DETAILED DESCRIPTION OF THE PREFERRED EMBODIMENT

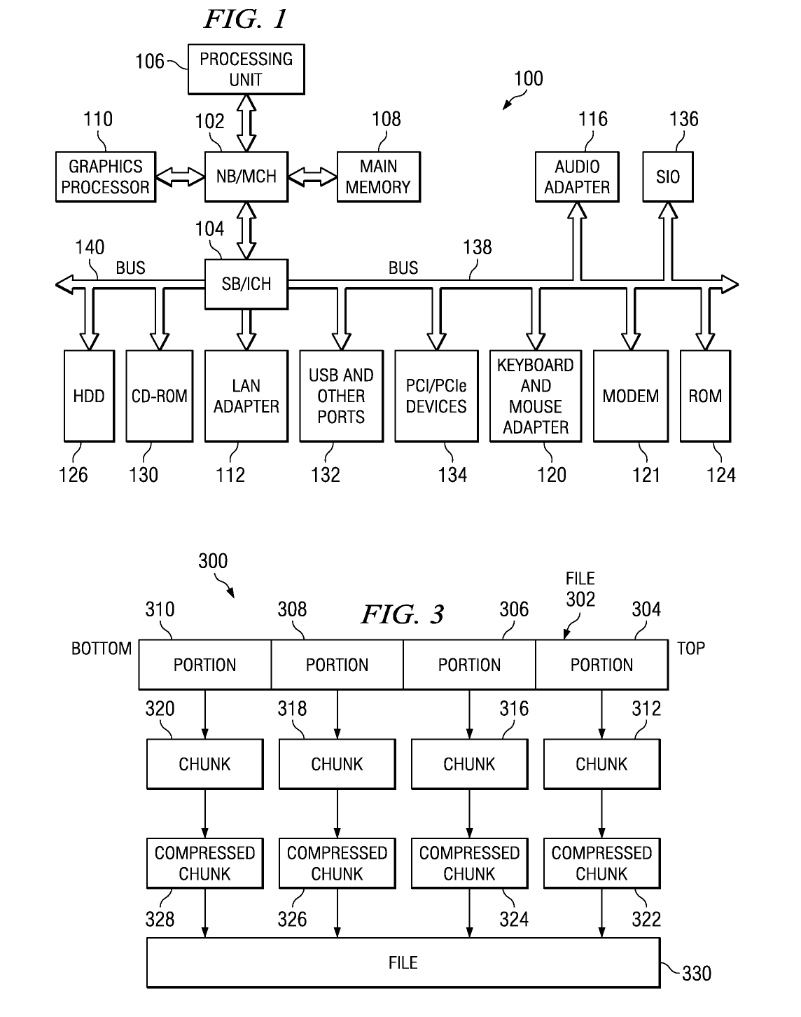

With reference now to FIG. 1, a block diagram of a data processing system is shown in which illustrative embodiments may be implemented. Data processing system 100 is an example of a computer in which computer usable program code or instructions implementing the processes may be located for the illustrative embodiments.

In the depicted example, data processing system 100 employs a hub architecture including a north bridge and memory controller hub (NB/MCH) 102 and a south bridge and input/output (I/O) controller hub (SB/ICH) 104. Processing unit 106, main memory 108, and graphics processor 110 are coupled to north bridge and memory controller hub 102. Processing unit 106 may contain one or more processors and even may be implemented using one or more heterogeneous processor systems. Graphics processor 110 may be coupled to the NB/MCH through an accelerated graphics port (AGP), for example.

In the depicted example, local area network (LAN) adapter 112 is coupled to south bridge and I/O controller hub 104 and audio adapter 116, keyboard and mouse adapter 120, modem 122, read only memory (ROM) 124, universal serial bus (USB) and other ports 132, and PCI/PCIe devices 134 are coupled to south bridge and I/O controller hub 104 through bus 138, and hard disk drive (HDD) 126 and CD-ROM 130 are coupled to south bridge and I/O controller hub 104 through bus 140. PCI/PCIe devices may include, for example, Ethernet adapters, add-in cards, and PC cards for notebook computers. PCI uses a card bus controller, while PCIe does not. ROM 124 may be, for example, a flash binary input/output system (BIOS). Hard disk drive 126 and CD-ROM 130 may use, for example, an integrated drive electronics (IDE) or serial advanced technology attachment (SATA) interface. A super I/O (SIO) device 136 may be coupled to south bridge and I/O controller hub 104.

An operating system runs on processing unit 106 and coordinates and provides control of various components within data processing system 100 in FIG. 1. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java™ programs or applications executing on data processing system 100. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 126, and may be loaded into main memory 108 for execution by processing unit 106. The processes of the illustrative embodiments may be performed by processing unit 106 using computer implemented instructions, which may be located in a memory such as, for example, main memory 108, read only memory 124, or in one or more peripheral devices.

The hardware in FIG. 1 may vary depending on the implementation. Other internal hardware or peripheral devices, such as flash memory, equivalent non-volatile memory, or optical disk drives and the like, may be used in addition to or in place of the hardware depicted in FIG. 1. Also, the processes of the illustrative embodiments may be applied to a multiprocessor data processing system.

In some illustrative examples, data processing system 100 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 108 or a cache such as found in north bridge and memory controller hub 102. A processing unit may include one or more processors or CPUs. The depicted examples in FIG. 1 and the above-described examples are not meant to imply architectural limitations. For example, data processing system 100 also may be a tablet computer, laptop computer, or telephone device in addition to taking the form of a PDA.

In a computer, memory is a limited resource. The term “computer” refers to any device powered by a processing unit, such as processing unit 106. Devices with relatively small amounts of memory, such as personal digital assistants (PDA) or cell phones, are particularly sensitive to memory usage. For example, most personal digital assistants and cell phones are capable of receiving emails. If several emails have large attachments, such as a digital photograph, the limited memory on the device may quickly fill up.

One popular way of conserving memory is file compression. However, in order to compress the file, the compression utility requires memory. At a minimum, the compression utility requires enough memory to hold the original file and the compressed file. Often, the compression utility is used to compress a file when memory is almost full, and memory usage must be conserved. If there is insufficient memory available for the compression utility to create the compressed file, the compression utility aborts the compression process when memory is full, before the compression process is complete.

The different embodiments recognize a need for a compression technique which can compress a file with a minimal amount of memory. Therefore, the illustrative embodiments described herein provide a computer implemented method, apparatus, and computer program code for compressing a file in a computer. An amount of memory available for use in the computer is determined. A size of the file is determined. A chunk size is determined based on the size of the file and the amount of memory available for use. A set of chunks are created by obtaining a chunk of chunk size from the file, and truncating the file an amount equal to the chunk size, until the file is completely truncated. A new file containing compressed chunks is created by repeatedly selecting a chunk from the set of chunks, compressing the chunk to form a compressed chunk, writing the compressed chunk to the new file, and deleting the chunk from the set of chunks, until each chunk in the set of chunks is deleted. The new file containing the compressed chunks is saved.

Currently available compression utilities require enough memory to hold the original file and the compressed file. Additional memory may also be required to temporarily hold intermediate files which are created during the process of compressing the file. In contrast, the different illustrative embodiments disclosed herein may be used to compress a file when the amount of free memory is less than five percent of the total size of the file. These different embodiments allow a file to be compressed using a minimal amount of available memory, using available compression utilities.

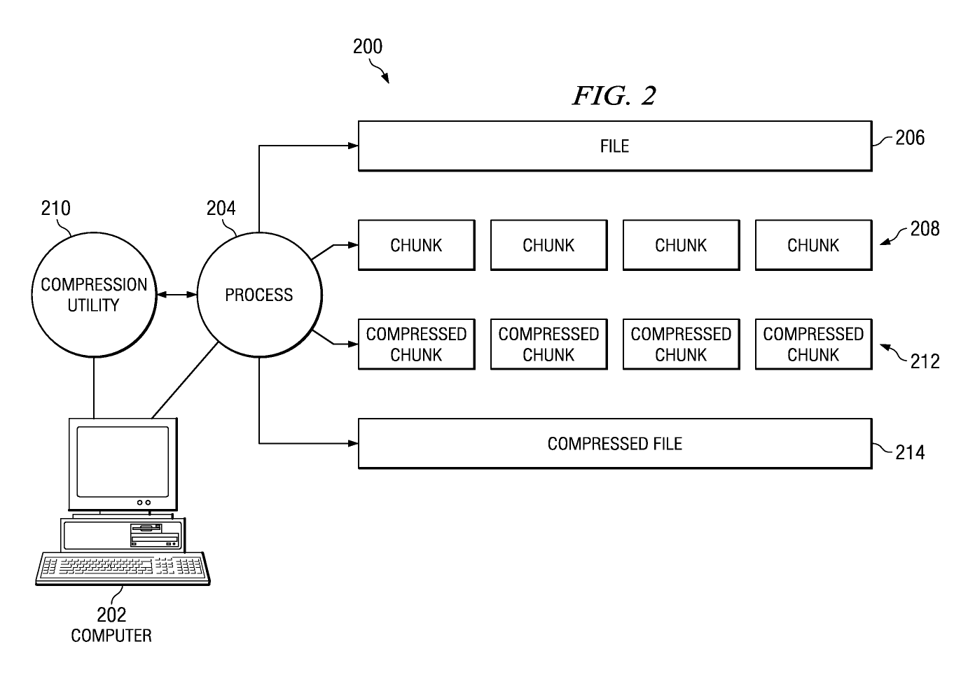

FIG. 2 is a block diagram of software components in accordance with an illustrative embodiment. In software components 200, the various components are located on computer 202. Computer 202 may be implemented in any type of computing device, such as, without limitation, data processing system 100 in FIG. 1.

Process 204 is a software process executing program code on computer 202. Process 204 repeatedly takes a chunk from file 206 until file 206 is converted into set of chunks 208. A set comprises one or more elements. Process 204 then takes a chunk from set of chunks 208, uses compression utility 210 to compress the chunk, and writes the compressed chunk to compressed file 214, until all chunks in set of chunks 208 have been compressed and written to compressed file 214.

FIG. 3 is a block diagram illustrating a file compression in accordance with an illustrative embodiment. In file compression process 300, file 302 is the original file before it is compressed. Based on the amount of free memory available for use in the computer, and based on the size of the file, a chunk size is determined.

In this example, file 302 is comprised of four portions, portions 304, 306, 308, and 310. A software process, such as process 204 in FIG. 2, obtains a portion from file 302, typically either from the bottom or the top of the file. In this example, each portion is obtained from the bottom of the file. For example, portion 304 is first obtained from the bottom of file 302. After a portion is removed from the file, it is referred to herein as a chunk. In this example, portion 304 is removed from file 302 and exists independent of file 302 as chunk 312. After chunk 312 is obtained, file 302 is truncated at the bottom, an amount equal to the size of chunk 312.

The next portion of the file, portion 306, is obtained from the bottom of file 302, as chunk 316. File 302 is truncated from the bottom equal to the size of chunk 316. The next portion, portion 308, is obtained from the bottom of file 302, as chunk 318. File 302 is truncated from the bottom equal to the size of chunk 318. The last portion, portion 310, is obtained from the bottom of file 302, as chunk 320. File 302 is truncated from the bottom equal to the size of chunk 320, leaving file 302 empty. Thus, each portion of file 302 is obtained, one at a time, to create chunks 312-320, until all the portions, portion 304-310, have been removed and file 302 is empty.

A chunk, such as chunk 312, is obtained and a compression utility, such as compression utility 210 in FIG. 2, is used to create a compressed chunk, such as compressed chunk 312. The chunk may be compressed to create a compressed chunk using any compression utility, such as zip, gzip, p7zip, ace, tar, rar, compress and stuffit.

Compressed chunk 312 is written to file 330, and chunk 304 is deleted. Chunk 316 is compressed to form compressed chunk 324, compressed chunk 324 is written to file 330, and chunk 316 is deleted. Chunk 318 is compressed to form compressed chunk 326, compressed chunk 326 is written to file 330, and chunk 318 is deleted. Chunk 320 is compressed to form compressed chunk 328, compressed chunk 328 is written to file 330, and chunk 320 is deleted. Thus, for each chunk obtained from file 302, the chunk is compressed, the compressed chunk is written to file 330, and the chunk is deleted until all chunks have been compressed, written to file 330, and deleted. File 330 contains the compressed version of file 302.

The example in FIG. 3 uses portions taken from the bottom of file 302. Those versed in the art will appreciate that the illustrative embodiments may also be implemented by obtaining a portion from the top of the file rather than the bottom of the file. Alternatively, two or more compressed chunks may be accumulated before writing these compressed chunks to compressed file 316. The number of compressed chunk accumulated may vary, but is selected to avoid using up memory needed for the compression process implemented in the compression utility. If the chunk size is selected to maximize memory use, then a single chunk may be used because two chunks would take up more memory than is available.

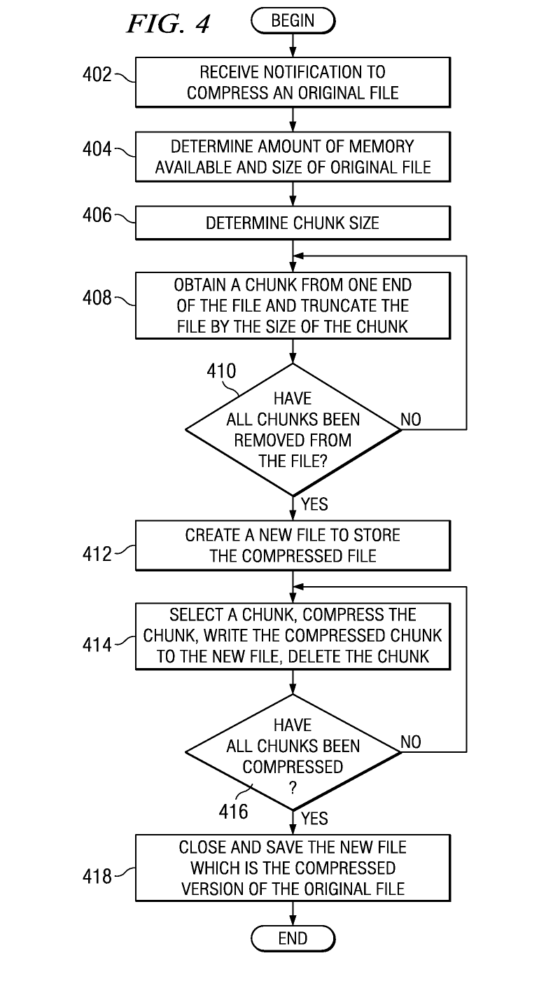

FIG. 4 is a flowchart of a process for compressing a file in accordance with an illustrative embodiment. The process in FIG. 4 is executed by software on a computer, such as process 204 in FIG. 2. The process begins by receiving a notification to compress an original file (step 402). The amount of memory available in the computer and the size of the original file is determined (step 404). Based on the amount of memory available and the size of the original file, a chunk size is determined (step 406). For example, the chunk size may normally be set to five percent of the original file, but the chunk size may be reduced further if the amount of memory available is less than five percent of the original file. In these examples, the chunk size is calculated so that the file can be broken into “n” chunks of approximately the same size, where “n” is greater than or equal to one. Thus, the size of the file divided by the chunk size gives the number of chunks into which the file will be divided.

A portion, such as portion 304 in FIG. 3, is obtained from one end of the file, such as the top or the bottom of the file, to create a chunk, such as chunk 312, and the file is truncated by the size of the chunk (step 408). A determination is made as to whether all the chunks have been removed from the original file (step 410). If the answer is “no” and all chunks have not been removed from the original file, then another chunk is obtained from the original file (step 408). The process can start at either the top or bottom of the original file. In steps 408 and 410, the process removes chunks from one end of the original file and continues removing chunks from the same end of the original file until all chunks have been removed.

If the answer in step 410 is “yes” and all chunks have been removed from the original file, a new file is created for storing the compressed version of the original file (step 412). A chunk is selected and compressed, the compressed chunk is written to the new file, and the original, uncompressed chunk is deleted (step 414). For example, in FIG. 3, portion 304 is selected to create chunk 312. Chunk 312 is compressed to create compressed chunk 322, compressed chunk 322 is written to file 330, and the original, uncompressed chunk, chunk 312, is deleted.

A determination is made as to whether all the chunks have been compressed (step 416). If the answer is “no” and all the chunks have not been compressed, then step 414 is repeated for the next chunk. The next chunk is selected and compressed, the compressed chunk is written to the new file, and the next chunk is deleted. Step 414 is repeated until all chunks have been compressed, the compressed chunks written to the new file, and all the chunks have been deleted. If the answer to step 416 is “yes” and all the chunks of the original file have been compressed, then the new file containing the compressed chunks is closed and saved (step 418) and the process ends. The new file contains the compressed version of the original file.

The illustrative embodiments described herein provide a computer implemented method, apparatus, and computer program code for compressing a file in a computer. An amount of memory available for use in the computer is determined. A size of the file is determined. A chunk size is determined based on the size of the file and the amount of memory available for use. A set of chunks are created by obtaining a chunk of chunk size from the file, and truncating the file an amount equal to the chunk size, until the file is completely truncated. A new file containing compressed chunks is created by repeatedly selecting a chunk from the set of chunks, compressing the chunk to form a compressed chunk, writing the compressed chunk to the new file, and deleting the chunk from the set of chunks, until each chunk in the set of chunks is deleted. The new file containing the compressed chunks is saved.

The different embodiments may be implemented in a computer running an operating system, such as Microsoft Windows®, Apple Mac-OS, and a Unix®-based operating system, such as Linux®, AIX®, HP-UX®, and Solaris®. The illustrative embodiments may be implemented in a shell script, and using a programming language such as assembler, C, C++, and Java.

The illustrative embodiments allow a file to be compressed in a way that requires only a minimal amount of memory for use during the compression of the file. For example, in a computer with both short-term memory (RAM) and long-term memory (disk), the invention requires only enough short-term memory to (1) hold one chunk, and (2) temporary memory to use when compressing the chunk using an available compression utility, such as zip or tar. Assuming that the original file is already in long-term memory, no additional long-term memory is needed, and at the end of the compression, long-term memory is freed up. The amount of long-term memory freed after the compression is completed is equal to the size of the original file minus the size of the compressed file. Compression can be performed with as little as five percent of the original file size available for use.

Similarly, in a device which has only one type of memory, such as a personal digital assistant or cellular/wireless phone, the invention can perform compression on a file with only enough memory available to (1) hold one chunk, and (2) temporary memory to use when compressing the chunk using an available compression utility, such as zip or tar. At the end of the compression process, the amount of memory freed after the compression is completed is equal to the size of the original file minus the size of the compressed file. Compression can be performed with as little as five percent of the original file size available for use.

On the other hand, conventional compression utilities require enough free memory to hold the (1) compressed file, (2) the original file, and (3) temporary memory to use for compressing the entire original file at once. Even if a compression utility deletes the original file after compression, the compression utility still requires enough memory to store the compressed file, and temporary memory, which significantly exceeds five percent of the original file size.

The flowchart and block diagrams in the figures illustrate the architecture, functionality, and operation of some possible implementations of systems, methods and computer program products according to various embodiments. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for compressing a file in a computer, the computer implemented method comprising:
determining an amount of memory available for use in the computer;
determining a size of the file;
determining a chunk size based on the size of the file and the amount of memory available for use;
creating a set of chunks by repeatedly obtaining a chunk of chunk size from the file, and truncating the file an amount equal to the chunk size, until the file is completely truncated;
creating a new file containing compressed chunks by repeatedly selecting a chunk from the set of chunks, compressing the chunk to form a compressed chunk, writing the compressed chunk to the new file, and deleting the chunk from the set of chunks, until each chunk in the set of chunks is deleted; and
saving the new file containing the compressed chunks.

2. The computer implemented method of claim 1, wherein the amount of memory available for use in the computer is less than or equal to five percent of the size of the file.

3. A computer program product comprising a computer usable medium including computer usable code for compressing a file in a computer, the computer program product comprising:
computer usable code for determining an amount of memory available for use in the computer;
computer usable code for determining a size of the file;
computer usable code for determining a chunk size based on the size of the file and the amount of memory available for use;
computer usable code for creating a set of chunks by repeatedly obtaining a chunk of chunk size from the file, and truncating the file an amount equal to the chunk size, until the file is completely truncated;
computer usable code for creating a new file containing compressed chunks by repeatedly selecting a chunk from the set of chunks, compressing the chunk to form a compressed chunk, writing the compressed chunk to the new file, and deleting the chunk from the set of chunks, until each chunk in the set of chunks is deleted; and
computer usable code for saving the new file containing the compressed chunks.

4. The computer program product of claim 3, wherein the amount of memory available for use in the computer is less than or equal to five percent of the size of the file.

5. A data processing system for compressing a file, the data processing system comprising:
a bus;
a storage device connected to the bus, wherein the storage device contains computer usable code;
a communications unit connected to the bus; and
a processing unit connected to the bus for executing the computer usable code, wherein the processing unit executes the computer usable code and determines an amount of memory available for use in the computer, determines a size of the file, determines a chunk size based on the size of the file and the amount of memory available for use, creates a set of chunks by repeatedly obtaining a chunk of chunk size from the file, and truncating the file an amount equal to the chunk size, until the file is completely truncated, creates a new file containing compressed chunks by repeatedly selecting a chunk from the set of chunks, compressing the chunk to form a compressed chunk, writing the compressed chunk to the new file, and deleting the chunk from the set of chunks, until each chunk in the set of chunks is deleted, and saves the new file containing the compressed chunks.

6. The data processing system of claim 5, wherein the amount of memory available for use in the computer is less than or equal to five percent of the size of the file.
